(19) United States
(12) Patent Application Publication
(10) Pub. No.: US 2006/0031571 A1
(43) Pub. Date: Feb. 9, 2006

(54) Data communications through a split connection proxy

(75) Inventors: Dwip N. Banerjee, Austin, TX (US); Kavitha Vittal Murthy Baratakke, Austin, TX (US); Lilian Sylvia Fernandes, Austin, TX (US); Venkat Venkatsubra, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 10/834,714

(22) Filed: Apr. 29, 2004

(51) Int. Cl. G06F 15/173

(52) U.S. Cl. 709/238

(57) ABSTRACT

Data communications through a split connection proxy in a data communications protocol, including receiving in a proxy from a client, asynchronously with respect to any other messages between the client and the proxy, one or more client messages including client message data items including a connection request for a connection between the client and the proxy, destination connection data identifying a destination server, and a message from the client to the destination server; and sending from the proxy to the server, asynchronously with respect to any messages between the client and the proxy and asynchronously with respect to any other messages between the proxy and the server, one or more proxy messages including proxy message data items including a connection request for a connection between the proxy and the destination server and the message from the client to the destination server.

### BACKGROUND OF THE INVENTION

1. Field of the Invention

The field of the invention is data processing, or, more specifically, methods, systems, and products for data communications through a split connection proxy.

2. Description of Related Art

Proxies play an important role in networked data communications in providing security and service while regulating access. There is, however, a performance penalty because of the dual connections that need to be set up in order to transfer data. All communications between a client and a server are handled by the proxy. The proxy receives communications from a client and forwards them to a server. The proxy receives responses from the server and forwards them to a client. Each such round of communications involves connection setup, data transfer, and connection teardown for two connections, one from client to proxy and another from proxy to client. Many of the administrative messages in connection setup, client to server communications, and connection teardown are synchronous, and the proxy often becomes a bottleneck.

Prior art data communications through a split connection proxy is explained in more detail with reference to FIG. 1. FIG. 1 sets forth a calling sequence diagram illustrating an exemplary prior art method of data communication between a client (108) and a server (106) through a split connection proxy (107). FIG. 1 includes a time line (442) illustrating elapsed time for message arrivals from the point of view of client (108). The time line assumes that the one-way travel time for each message is 10 milliseconds. The proxy is said to be a split connection proxy because it implements two TCP connections with two three way handshakes. ‘TCP’ is the ‘Transmission Control Protocol,’ a well-known, connection-oriented data communications protocol that operates in the transport layer of the OSI data communications model. One three-way handshake is between the client and the proxy and includes: a connection request, SYN message (402); an acknowledgement of the connection request and a corresponding request to create a client-side connection, SYN-ACK message (404); and an acknowledgement from the client of the client-side connection request, ACK (406). The other three-way handshake is between the proxy and the server and includes: a connection request, SYN message (412); an acknowledgement of the connection request and a corresponding request to create a client-side connection, SYN-ACK message (414); and an acknowledgement from the client of the client-side connection request, ACK (416).

The second three-way handshake is synchronous with respect to the first in that it does not begin until after the proxy receives the server's address and port number from the client in the destination request message (408). To the extent that the proxy provides security servers, a common pattern of usage, the DEST REQ message (408) may in fact be implemented as several messages, for client authentication and authorization for example. In the case of a SOCKS v.5 proxy, for example, the authentication messages may include:
a version identification/authentication method selection message from the client to the proxy an authentication method selection response from the proxy
transmission of authentication data according to the selection authentication method
acknowledgment from the proxy to the client of authentication

Only after successful authentication would such a SOCKS client send its SOCKS request data providing the destination address and port number for the server and receive from the proxy a replay to the SOCKS request message.

The exemplary message traffic of FIG. 1 is synchronous. In fact, the well-known ‘SYN’ flag in a TCP message stand for ‘synchronize.’ The proxy's three-way connection handshake with the server (412, 414, 416) therefore does not even begin until after the proxy has completed the connection handshake with the client (402, 404, 406), optionally authenticated the client, and received and acknowledged (408, 410) the destination data for the server.

The illustrated communications between client (108) and server (106) continue with a client request (418) directed to the server and forwarded (420) to the server through proxy (107). The client request may arrive at the server before the server sends its connection acknowledgement (416), in which case the client request (420) and the acknowledgement (416) may be included in the same message and arrive at the server at the same time, shown in FIG. 1 as the 70 millisecond mark on time line (442). Server (106) formulates a response (422) to the client's request and sends it back through the proxy to the client (424). The client request (418) and the server's response may be of any kind. The client request/server response messages may, among others, include the following, for example:
An email posting from an email client and a responsive acknowledgement of the posting from the server
An HTTP posting from a browser client and a responsive acknowledgment of the posting from the server
An HTTP REQUEST message from a browser client and an HTTP RESPONSE message from the server conveying a web page for display through the client browser
An SMS posting from an instant messaging client and an acknowledgment of the posting

For purposes of explanation, the client request and the server response are shown in FIG. 1 as a single exchange, although as a practical matter, many such exchanges may occur during this connected phase of communications. In the example, of FIG. 1, after the client receives the pertinent response (424) from the server, client (108) begins the process of terminating the connection. There are several ways in TCP that the termination messages may be sequenced. The sequence shown, with separate FIN and ACK messages is a common sequence in which the proxy does not know when it receives the first FIN message (426) whether any further messages may be received for the connection from the server. The proxy therefore acknowledges (428) the client's termination request, sends a FIN message (434) to the server, and waits for the server's FIN (438) before terminating (430, 432) with the client (108).

In the example of FIG. 1, establishing split connections through a proxy, effecting a simple exchange of application-level messages, and terminating the connection required at least twenty messages and at least 140 milliseconds of message time from the point of view of the client. As few of two of the messages, apparently as little as 5% of the message traffic in this example, were for substantive application traffic. There is an ongoing need for improvement in the efficiency of data communications through split connection proxies.

### SUMMARY OF THE INVENTION

Method, systems, and products are disclosed for data communications through a split connection proxy in a data communications protocol, including receiving in a proxy from a client, asynchronously with respect to any other messages between the client and the proxy, one or more client messages including client message data items including a connection request for a connection between the client and the proxy, destination connection data identifying a destination server, and a message from the client to the destination server; and sending from the proxy to the server, asynchronously with respect to any messages between the client and the proxy and asynchronously with respect to any other messages between the proxy and the server, one or more proxy messages including proxy message data items including a connection request for a connection between the proxy and the destination server and the message from the client to the destination server.

In typical embodiments, receiving one or more client messages also includes receiving only one client message including all the client message data items. In typical embodiments, the received client message data items also include an identification of an authentication method and client authentication data. In typical embodiments, sending one or more proxy messages also includes sending only one proxy message comprising all the proxy message data items. Typical embodiments include receiving in the proxy from the server, asynchronously with respect to any other messages between the proxy and the server, a server response message including a message responding to the message from the client to the destination server. Typical embodiments include receiving in the proxy from the server, asynchronously with respect to any other messages between the proxy and the server, a server response message including an acknowledgment of the connection request for a connection between the proxy and the server, a server connection request for a connection between the proxy and the server, and a message responding to the message from the client to the destination server.

Typical embodiments also include sending, asynchronously with respect to any other messages between the proxy and the client, from the proxy to the client in response to the server response message, a proxy response message including the message responding to the message from the client to the destination server.

Typical embodiments also include receiving in the proxy from the client a message terminating the connection between the client and the proxy, and terminating the connection between the client and the proxy without acknowledgment. Typical embodiments also include sending from the proxy to the server, in response to the message from the client terminating the connection between the client and the proxy, a message terminating the connection between the proxy and the server, and terminating the connection between the proxy and the server without acknowledgment.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a calling sequence diagram illustrating an exemplary prior art method of data communication between a client and a server through a split connection proxy.

FIG. 2 sets forth a line drawing of an exemplary system architecture in which various embodiments may be implemented.

FIG. 3 sets forth a block diagram of automated computing machinery comprising a computer useful for data communications through a split connection proxy.

FIG. 4 sets forth a flow chart illustrating a method of data communications through a split connection proxy in a data communications in a data protocol.

FIG. 5 sets forth a calling sequence diagram illustrating an exemplary calling sequence useful in methods and systems for data communication between a client and a server through a split connection proxy.

FIG. 6 sets forth a calling sequence diagram illustrating an exemplary calling sequence useful in methods and systems for data communication between a client and a server through a split connection proxy.

FIG. 7 sets forth a flow chart illustrating an exemplary method of terminating data communications established through a split connection proxy in a data communications between the client and the proxy without acknowledgment.

### DETAILED DESCRIPTION OF EXEMPLARY EMBODIMENTS

### Introduction

The present invention is described to a large extent in this specification in terms of methods for data communications through a split connection proxy. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Data Communications Through A Split Connection Proxy

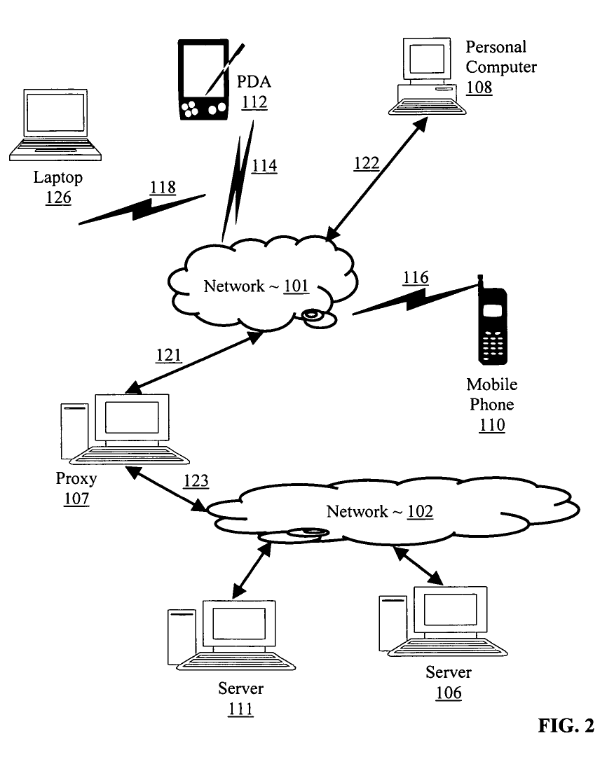

Methods, systems, and products are disclosed for data communications through a split connection proxy according to embodiment of the present invention with reference to the drawings, beginning with FIG. 2. FIG. 2 sets forth a line drawing of an exemplary system architecture in which various embodiments of the present invention may be implemented. The system of FIG. 2 operates generally to increase data communications efficiency by sending messages asynchronously and by combining the contents of messages so that fewer messages are sent and the ones that are sent are sent promptly, asynchronously, rather than delaying by waiting for one another. The example of FIG. 2 includes a proxy (107) connected to network (102) through wireline connection (123) and to network (101) through wireline connection (121). Proxy (107) provides split connection data communication between clients on network (101) and servers (106, 111) on network (102). Proxy (107) operates generally by receiving from a client one or more client messages that include a connection request for a connection between the client and the proxy, destination connection data identifying a destination server, and a message from the client to the destination server. Proxy (107) receives the client messages asynchronously with respect to other messages between a client and the proxy, and the connection request for a connection between the client and the proxy, destination connection data identifying a destination server, and a message from the client to the destination server may be combined into as few as one client message. Proxy (107) also operates generally by sending to a server (111, 106) one or more proxy messages that include proxy message data items including a connection request for a connection between the proxy and the destination server and the message from the client to the destination server. The proxy sends the proxy messages asynchronously with respect to messages between the client and the proxy and asynchronously with respect to any other messages between the proxy and the server, and the connection request for a connection between the proxy and the destination server and the message from the client to the destination server may be combined into one proxy message.

In the terminology of this specification, a ‘client’ is any computer or computer process capable of requesting a service or data provided by another computer or program. A physical device such as a laptop, a PDA, or a desktop can be a client. An application running on a computer that relies on a server is also a client. Such applications include e-mail clients, FTP clients and so on. A ‘proxy’ is any computer or computer process that provides an intervening connection between a client and a server. That is, a proxy resides between a client application or client application, such as a web browser or an email client, and a destination server. In this specification, such a destination server is often referred to simply as a ‘server.’ Proxy servers may support proxy protocols to authenticate authorized users. Proxy protocols include SOCKS, msproxy, SSMP, and so on. A ‘server’ is a computer on an internet or other network that responds to requests or commands from a client. Types of servers include FTP servers, IRC servers, mail servers, news servers, web servers and so on. Any computer can function as a client, a proxy, or a server, the distinguishing feature being the function rather than the device. When a proxy receives a connection request from a client, it is functioning as a server. When a proxy requests a connection of a server, it is functioning as a client. In the terminology of TCP, clients and servers are referred to as local hosts and foreign hosts. In this specification, for clarity of explanation, the terms ‘client,’ ‘server,’ and ‘proxy’ are used. ‘Network’ means any networked coupling for data communications among computers or computer systems. Examples of networks useful with the invention include intranets, extranets, internets, local area networks, wide area networks, and other network arrangements as will occur to those of skill in the art.

Network (101) may be, for example, a local area network (“LAN”) for which proxy (107) provides security services, firewall protection, network address translation, and so on. Network (102) may be a wide area network, for example, including a large internet. The clients in the architecture of FIG. 2 include a laptop computer (126) connected to network (101) through a wireless connection (118), a personal digital assistant (“PDA”) (112) connected to the network through a wireless connection (114), personal computer (108) connected to network (101) through wireline connection (122), and a network-enabled mobile telephone (110) connected to the network through a wireless connection (116). Servers (106, 111) may provide a wide variety of service through network (102) including, for example, HTTP or ‘web’ services, email services, instant messaging service, security services, applications services, and others as will occur to those of skill in the art.

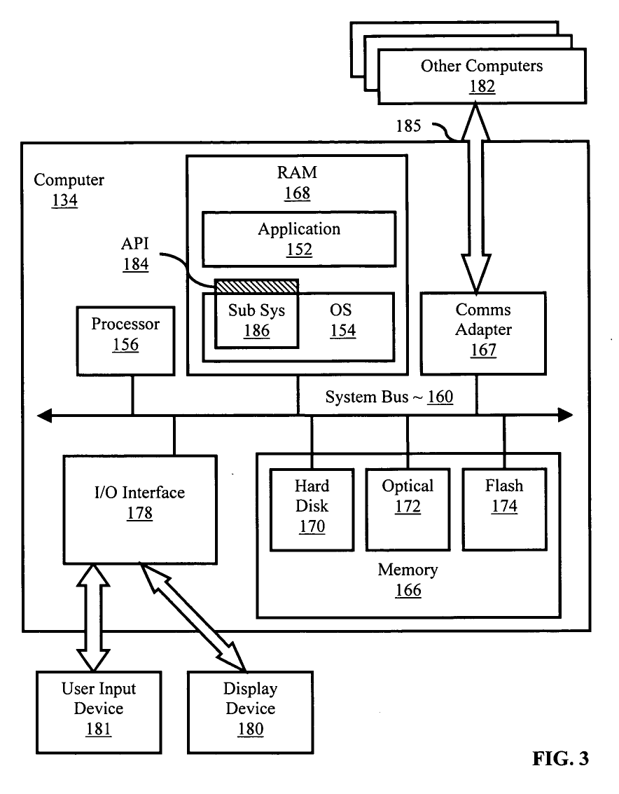

As mentioned, clients, proxies, and servers are computers. The term ‘computer,’ in this specification means any automated computing machinery. ‘Computer’ includes not only general purpose computers such as laptops, personal computers, minicomputers, and mainframes, but also devices such as PDAs, network-enabled handheld devices, internet-enabled mobile telephones, and so on. For further explanation, FIG. 3 sets forth a block diagram of automated computing machinery comprising a computer (134) useful according to various embodiments of the present invention for data communications through a split connection proxy. The computer (134) of FIG. 3 includes at least one computer processor (156) or ‘CPU’ as well as random access memory (168) (“RAM”). Stored in RAM (168) is an application program (152). Application programs useful in accordance with various embodiments of the present invention include browsers, word processors, spreadsheets, database management systems, email clients, proxy services, and so on, as will occur to those of skill in the art. Also stored in RAM (168) is an operating system (154). Operating systems useful in computers according to embodiments of the present invention include Unix, Linux™, Microsoft NT™, and others as will occur to those of skill in the art. Transport and network layer software components such TCP/IP clients and services are typically provided as components of operating systems, including Microsoft Windows™, IBM's AIX™, Linux™, and so on.

Operating system (154) includes a sub-system (186) for data communication, such as, for example, a TCP service. The subsystem for data communication exposes data communications functions for use by applications through an API (184). TCP API functions include, for example:
listen( )—activates a socket, instructing the communications subsystem that a server port is ready to begin operations, begin accepting connections on a socket
accept( )—accepts a connection on a socket from the subsystem on a server
acceptEx( )—accepts a new connection on a server and receives the first block of data sent by a client
connectEx( )—requests a connection to a server from a client through a specified socket and optionally sends data when the connection is established
connect( )—requests a connection to a server from a client on a specified socket
send( )—sends a message through a connection on a server or a client
recv( )—retrieves from the subsystem a message received on a connection to a calling application on a server or a client

The example computer (134) of FIG. 3 includes computer memory (166) coupled through a system bus (160) to processor (156) and to other components of the computer. Computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer (134) of FIG. 3 includes communications adapter (167) that implements connections for data communications (185) to other computers (182). Communications adapters (167) implement the hardware level of data communications connections through which client computers and servers send data communications directly to one another and through networks. Examples of communications adapters (167) include modems for wired dial-up connections, Ethernet (IEEE 802.3) adapters for wired LAN connections, 802.11 adapters for wireless LAN connections, and Bluetooth adapters for wireless microLAN connections.

The example of FIG. 3 also includes a user input device (181) and a display device (180). Examples of display devices include GUI screens, text screens, touch sensitive screens, Braille displays, and so on. Examples of user input devices include mice, keyboards, numeric keypads, touch sensitive screens, microphones, and so on. The example computer of FIG. 3 includes one or more input/output interface adapters (178). Input/output interface adapters (178) in computer (134) include hardware that implements user input/output to and from user input devices (181) and display devices (180).

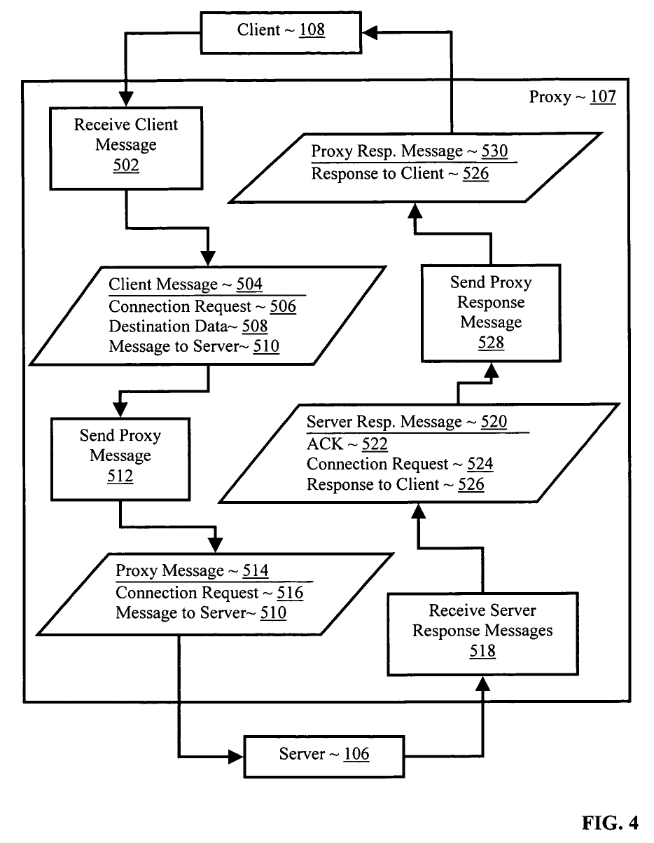

By way of further explanation, FIG. 4 sets forth a flow chart illustrating a method of data communications through a split connection proxy in a data communications protocol according to at least one embodiment of the present invention that includes receiving (502) in a proxy (107) from a client (108), asynchronously with respect to any other messages between the client and the proxy, one or more client messages (504) containing client message data items including a connection request (506) for a connection between the client and the proxy, destination connection data (508) identifying a destination server, and a message (510) from the client to the destination server. The method of FIG. 4 also includes sending (512) from the proxy (107) to the server (106), asynchronously with respect to any messages between the client and the proxy and asynchronously with respect to any other messages between the proxy and the server, one or more proxy messages (514) containing proxy message data items including a connection request (516) for a connection between the proxy and the destination server and the message (510) from the client to the destination server.

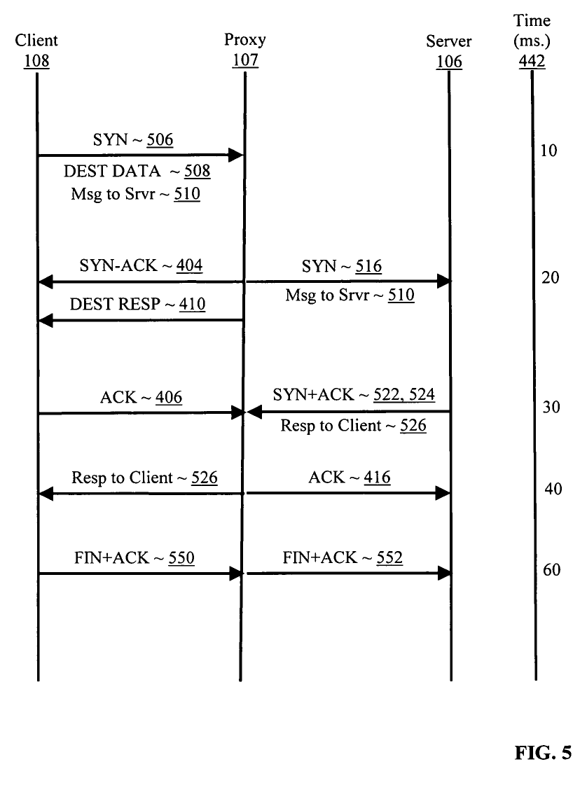

The asynchronous nature of these communications is explained with reference to FIG. 5. FIG. 5 sets forth a calling sequence diagram illustrating an exemplary calling sequence useful in methods and systems for data communication between a client (108) and a server (106) through a split connection proxy (107). In the method of FIG. 4, receiving (502) one or more client messages may be carried out by receiving only one client message that includes all the client message data items. In the example of FIG. 5, proxy (107) receives a connection request (506) for a connection between the client and the proxy, destination connection data (508) identifying the destination server (106), and a message (510) from the client (108) to the destination server (106) all in the same message from client (108). The destination data (508) is the kind of destination server address and port data that would ordinarily be provided, for example, in a SOCKS message in a system where proxy (107) is a SOCKS server, and the client TCP service is typically configured with the network address and port number of its firewall or proxy. The port number for a SOCKS server, for example, is usually 1080. In the TCP service on client (108), the network address and port number for the proxy is known as soon as the client calls a TCP connect( ) function or its equivalent.

The processing sequence of FIG. 5 may be implemented, for example, by using a TCP connectEx( ) function to take as additional call parameters in client (108) the network address and port number (508) of the destination server as well as the contents of a first message (510) from the client to the destination server. In FIG. 4 and FIG. 5, the client message data items in client message (504) are shown as including a connection request (506) for a connection between the client and the proxy, destination connection data (508) identifying the destination server (106), and a message (510) from the client (108) to the destination server (106) all in the same message from client (108). It useful to note, however, that client message data items may also include, and in fact often do include, an identification of an authentication method and client authentication data, as is common, for example in a SOCKS protocol. To the extent that it is useful to do so, identification of an authentication method and client authentication data is included in the parameters of a connectEx( ) call in client (108).

According to the sequence of FIG. 5 and the method of FIG. 4, therefore, the proxy receives the connection request (506) for a connection between the client and the proxy, destination connection data (508) identifying the destination server (106), and the message (510) from the client (108) to the destination server (106) all at the same time, with no need to wait for completion of the traditional three-way handshake before receiving the destination connection data (508) identifying the destination server (106) and the message (510) from the client (108) to the destination server (106).

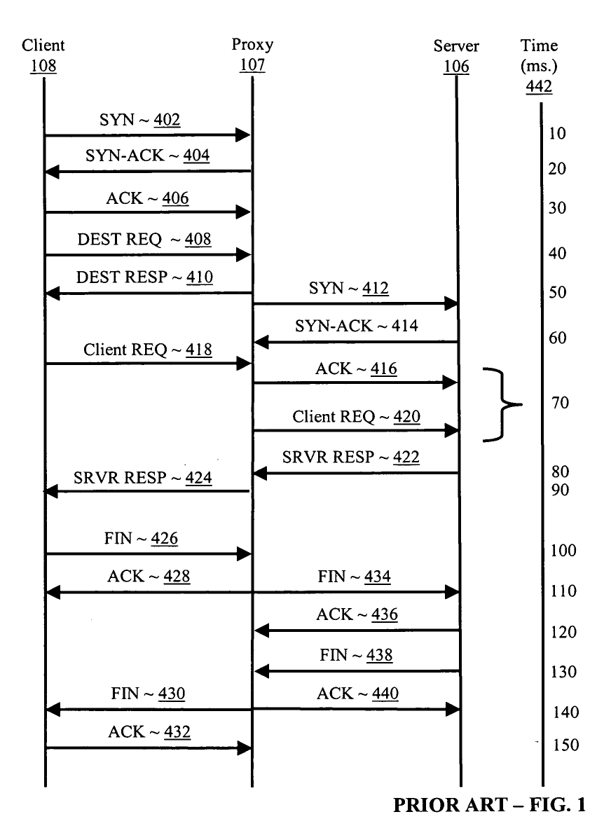

According to the method of FIG. 4, sending (514) one or more proxy messages may be carried out by sending only one proxy message that includes all the proxy message data items. That is, the proxy can combine through its own call to connectEx( ) its connection request (516) to the server and the message (510) from the client to the destination server in the same message that may arrive at the server at about the 20 millisecond mark on the time line. This procedure has the effect of communicating the message (510) from the client to the server in about 20 milliseconds using only two messages, contrasting well with the 10 messages and 70 milliseconds needed for the same result in the prior art method shown in FIG. 1.

The method of FIG. 4 also includes receiving (518) in the proxy (107) from the server (106), asynchronously with respect to any other messages between the proxy and the server, a server response message (520) that includes a message (526) responding to the message from the client to the destination server. The method of FIG. 4 also may be carried out by receiving (518) in the proxy from the server, asynchronously with respect to any other messages between the proxy and the server, a server response message (520) that includes an acknowledgment (522) of the connection request for a connection between the proxy and the server, a server connection request (524) for a connection between the proxy and the server, and a message (526) responding to the message from the client to the destination server. That is, a message (526) responding to the message from the client to the destination server may be included in any handshake messages from the server to the proxy that may be outstanding in the process of setting up the connection between the proxy and the server. Such messages may be outstanding because according to embodiments of the present invention they are typically sent asynchronously with respect to a message (526) responding to the message from the client to the destination server.

Said another way, server (106) does not wait until handshake completion before preparing a response to a client request. When the response to the client request is ready, therefore, a handshake message may not yet have been sent and the server response message therefore may include both the handshake message, such as SYN-ACK, and a message (526) responding to the message from the client to the destination server. In the example of FIG. 5, the message (526) responding to the message from the client to the destination server is sent in the SYN-ACK handshake message from the server to the proxy. That is, the responsive TCP message has its SYN flag set (522) and its ACK flag set (524) and its payload segment contains a response (526) to the message (510) from the client to the destination server.

If, for example, client (108) is an email client, server (106) is an email server, and the message (510) from the client to the server is an email message, then the server response message (520) may be an acknowledgement of receipt of the email message. If client (108) is a web client, that is, a browser on a personal computer, server (106) is a web server, that is, an HTTP server, and the message (510) from the client to the server is an HTTP REQUEST message asking for a web page identified by a URL, then the server response message (520) may be an HTTP RESPONSE message containing the web page identified by the URL. If, for example, client (108) is an SMS (‘Small Message Service’) client, server (106) is an SMS server, and the message (510) from the client to the server is an instant text message, then the server response message (520) may be an acknowledgement of receipt of the instant text message. And so on, for any exchange of application-level messages as will occur to those of skill in the art.

The method of FIG. 4 also includes sending (528), asynchronously with respect to any other messages between the proxy and the client, from the proxy (107) to the client (108) in response to the server response message (520), a proxy response message (530) containing the message (526) responding to the message from the client to the destination server. At this point in processing according to the method of FIG. 4 and the sequence of FIG. 5, proxy (107) has established a split connection between client (108) and server (106) and delivered one exchange of substantive, application-level messages (510, 526) such as an email posting, an HTTP message, an instant text message, or the like, all within about 40 milliseconds using only eight messages. Again, this performance contrasts well with the 12 messages and 90 milliseconds needed for the same result in the prior art method shown in FIG. 1.

The mechanism for combining data with the SYN or the SYN/ACK packet exchange during the initial TCP connection setup is conformant with the provisions of the TCP standard in RFC793. Vendors can provide an appropriate API for user applications to leverage this capability in a split-connection proxy according to embodiments of the present invention.

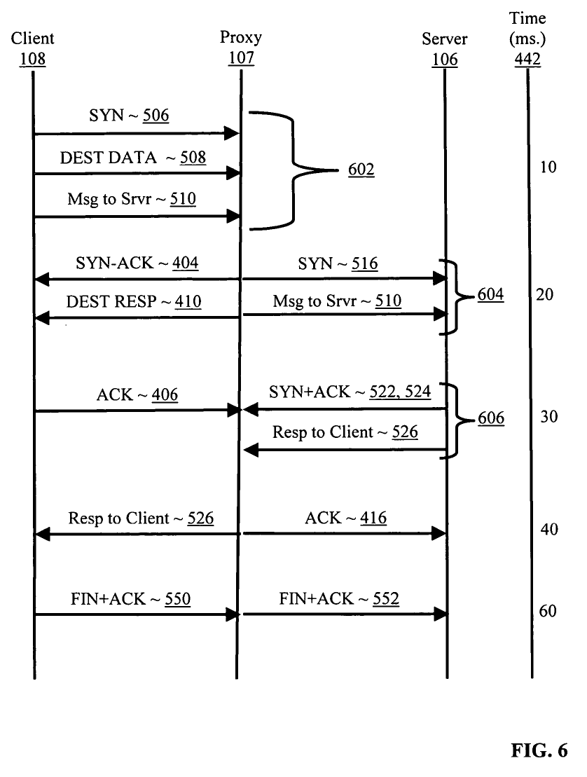

By way of further explanation, FIG. 6 sets forth a calling sequence diagram illustrating an exemplary calling sequence useful in methods and systems for data communication between a client (108) and a server (106) through a split connection proxy (107) in which receiving a connection request (506) for a connection between the client and the proxy, destination connection data (508) identifying a destination server, and a message (510) from the client to the destination server is carried out by receiving a connection request (506) for a connection between the client and the proxy, destination connection data (508) identifying a destination server, and a message (510) from the client to the destination server in separate messages (602). Because the separate messages (602) are received asynchronously with respect to other messages between the client and the server, in particular without waiting for the handshake messages (404, 406), the messages containing the connection request (506) for a connection between the client and the proxy, the destination connection data (508) identifying a destination server, and the message (510) from the client to the destination server all arrive at the proxy (107), not simultaneously, of course, but at approximately the same time as they would arrive if the were encapsulated in the same message, as they are in the illustrated method of FIG. 5.

The method of FIG. 6 also includes sending from the proxy (107) to server (106) one or more proxy messages containing proxy message data items including a connection request (516) for a connection between the proxy and the destination server and the message (510) from the client to the destination server, again is separate messages (604). Again, because they are sent asynchronously with respect to other messages between the client and the proxy and the server, the connection request (516) for a connection between the proxy and the destination server and the message (510) from the client to the destination server both (604) arrive at the server (106) not simultaneously, but at approximately the same time as they would arrive if the were encapsulated in the same message, as they are in the illustrated method of FIG. 5.

The method of FIG. 6 also includes receiving in the proxy from the server, asynchronously with respect to any other messages between the proxy and the server, an acknowledgment (522) of the connection request for a connection between the proxy and the server, a server connection request (524) for a connection between the proxy and the server, and a message (526) responding to the message from the client to the destination server, with the message (526) responding to the message from the client to the destination server in a separate message (606). Again, because they are sent asynchronously with respect to other messages between the client and the proxy and the server, the acknowledgment (522) of the connection request for a connection between the proxy and the server, the server connection request (524) for a connection between the proxy and the server, and the message (526) responding to the message from the client to the destination server arrive at the proxy (107) not simultaneously, but at approximately the same time as they would arrive if the were encapsulated in the same message, as they are in the illustrated method of FIG. 5.

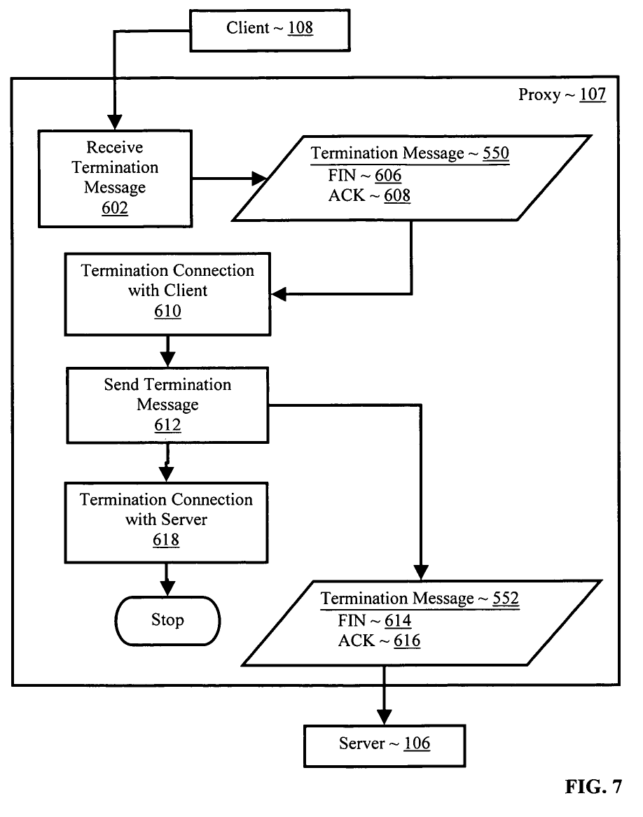

By way of further explanation, FIG. 7 sets forth a flow chart illustrating an exemplary method of terminating data communications connections established through the method of FIG. 4. The method of FIG. 7 includes receiving (602) in the proxy (107) from the client (108) a message (550) terminating the connection between the client and the proxy and terminating (610) the connection between the client and the proxy without acknowledgment. The method of FIG. 7 also includes sending (612) from the proxy (107) to the server (106), in response to the message (550) from the client terminating the connection between the client and the proxy, a message (552) terminating the connection between the proxy and the server and terminating (618) the connection between the proxy and the server without acknowledgment. There is a FIN-ACK message in standard TCP, but it is not used to initiate connection termination. One way to implement the method of FIG. 7, therefore, is to program the TCP services in client (108), proxy (107), server (106) to send a TCP message with both the FIN flag set and also the ACK flag set to initiate connection termination. Such an implementation includes programming the TCP services in client (108), proxy (107), server (106) to recognize such an initial FIN-ACK message, upon receipt, as an instruction to terminate the connection through which it was received without further handshake traffic. To the extent that a proxy or server receiving such a message might have additional data for the connection that has not yet been sent, it is dropped.

At this point in processing according to the processing sequence of FIG. 5, proxy (107) has established a split connection between client (108) and server (106) and delivered one exchange of substantive, application-level messages (510, 526) such as an email posting, an HTTP message, an instant text message, or the like, and terminated the split connection, all within about 60 milliseconds using only eight messages. This performance is substantially more efficient that the 20 messages and 150 milliseconds needed for the same result in the prior art method shown in FIG. 1.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of data communications through a split connection proxy in a data communications protocol, the method comprising:
receiving in a proxy from a client, asynchronously with respect to any other messages between the client and the proxy, one or more client messages comprising client message data items including a connection request for a connection between the client and the proxy, destination connection data identifying a destination server, and a message from the client to the destination server; and
sending from the proxy to the server, asynchronously with respect to any messages between the client and the proxy and asynchronously with respect to any other messages between the proxy and the server, one or more proxy messages comprising proxy message data items including a connection request for a connection between the proxy and the destination server and the message from the client to the destination server.

2. The method of claim 1 wherein receiving one or more client messages further comprises receiving only one client message comprising all the client message data items.

3. The method of claim 1 wherein the received client message data items further include an identification of an authentication method and client authentication data.

4. The method of claim 1 wherein sending one or more proxy messages further comprises sending only one proxy message comprising all the proxy message data items.

5. The method of claim 1 further comprising receiving in the proxy from the server, asynchronously with respect to any other messages between the proxy and the server, a server response message comprising a message responding to the message from the client to the destination server.

6. The method of claim 1 further comprising receiving in the proxy from the server, asynchronously with respect to any other messages between the proxy and the server, a server response message comprising an acknowledgment of the connection request for a connection between the proxy and the server, a server connection request for a connection between the proxy and the server, and a message responding to the message from the client to the destination server.

7. The method of claim 3 further comprising sending, asynchronously with respect to any other messages between the proxy and the client, from the proxy to the client in response to the server response message, a proxy response message comprising the message responding to the message from the client to the destination server.

8. The method of claim 1 further comprising:
receiving in the proxy from the client a message terminating the connection between the client and the proxy; and
terminating the connection between the client and the proxy without acknowledgment.

9. The method of claim 4 further comprising:
sending from the proxy to the server, in response to the message from the client terminating the connection between the client and the proxy, a message terminating the connection between the proxy and the server; and
terminating the connection between the proxy and the server without acknowledgment.

10. A system of data communications through a split connection proxy in a data communications protocol, the system comprising:
means for receiving in a proxy from a client, asynchronously with respect to any other messages between the client and the proxy, one or more client messages comprising client message data items including a connection request for a connection between the client and the proxy, destination connection data means for identifying a destination server, and a message from the client to the destination server; and
means for sending from the proxy to the server, asynchronously with respect to any messages between the client and the proxy and asynchronously with respect to any other messages between the proxy and the server, one or more proxy messages comprising proxy message data items including a connection request for a connection between the proxy and the destination server and the message from the client to the destination server.

11. The system of claim 10 wherein means for receiving one or more client messages further comprises means for receiving only one client message comprising all the client message data items.

12. The system of claim 10 wherein the received client message data items further include an identification of an authentication system and client authentication data.

13. The system of claim 10 wherein means for sending one or more proxy messages further comprises means for sending only one proxy message comprising all the proxy message data items.

14. The system of claim 10 further comprising means for receiving in the proxy from the server, asynchronously with respect to any other messages between the proxy and the server, a server response message comprising a message means for responding to the message from the client to the destination server.

15. The system of claim 10 further comprising means for receiving in the proxy from the server, asynchronously with respect to any other messages between the proxy and the server, a server response message comprising an acknowledgment of the connection request for a connection between the proxy and the server, a server connection request for a connection between the proxy and the server, and a message means for responding to the message from the client to the destination server.

16. The system of claim 12 further comprising means for sending, asynchronously with respect to any other messages between the proxy and the client, from the proxy to the client in response to the server response message, a proxy response message comprising the message means for responding to the message from the client to the destination server.

17. The system of claim 10 further comprising:
means for receiving in the proxy from the client a message means for terminating the connection between the client and the proxy; and
means for terminating the connection between the client and the proxy without acknowledgment.

18. The system of claim 13 further comprising:
means for sending from the proxy to the server, in response to the message from the client means for terminating the connection between the client and the proxy, a message means for terminating the connection between the proxy and the server; and
means for terminating the connection between the proxy and the server without acknowledgment.

19. A computer program product of data communications through a split connection proxy in a data communications protocol, the computer program product comprising:
a recording medium;
means, recorded on the recording medium, for receiving in a proxy from a client, asynchronously with respect to any other messages between the client and the proxy, one or more client messages comprising client message data items including a connection request for a connection between the client and the proxy, destination connection data means, recorded on the recording medium, for identifying a destination server, and a message from the client to the destination server; and
means, recorded on the recording medium, for sending from the proxy to the server, asynchronously with respect to any messages between the client and the proxy and asynchronously with respect to any other messages between the proxy and the server, one or more proxy messages comprising proxy message data items including a connection request for a connection between the proxy and the destination server and the message from the client to the destination server.

20. The computer program product of claim 19 wherein means, recorded on the recording medium, for receiving one or more client messages further comprises means, recorded on the recording medium, for receiving only one client message comprising all the client message data items.

21. The computer program product of claim 19 wherein the received client message data items further include an identification of an authentication computer program product and client authentication data.

22. The computer program product of claim 19 wherein means, recorded on the recording medium, for sending one or more proxy messages further comprises means, recorded on the recording medium, for sending only one proxy message comprising all the proxy message data items.

23. The computer program product of claim 19 further comprising means, recorded on the recording medium, for receiving in the proxy from the server, asynchronously with respect to any other messages between the proxy and the server, a server response message comprising a message means, recorded on the recording medium, for responding to the message from the client to the destination server.

24. The computer program product of claim 19 further comprising means, recorded on the recording medium, for receiving in the proxy from the server, asynchronously with respect to any other messages between the proxy and the server, a server response message comprising an acknowledgment of the connection request for a connection between the proxy and the server, a server connection request for a connection between the proxy and the server, and a message means, recorded on the recording medium, for responding to the message from the client to the destination server.

25. The computer program product of claim 21 further comprising means, recorded on the recording medium, for sending, asynchronously with respect to any other messages between the proxy and the client, from the proxy to the client in response to the server response message, a proxy response message comprising the message means, recorded on the recording medium, for responding to the message from the client to the destination server.

26. The computer program product of claim 19 further comprising:
means, recorded on the recording medium, for receiving in the proxy from the client a message means, recorded on the recording medium, for terminating the connection between the client and the proxy; and
means, recorded on the recording medium, for terminating the connection between the client and the proxy without acknowledgment.

27. The computer program product of claim 22 further comprising:
means, recorded on the recording medium, for sending from the proxy to the server, in response to the message from the client means, recorded on the recording medium, for terminating the connection between the client and the proxy, a message means, recorded on the recording medium, for terminating the connection between the proxy and the server; and
means, recorded on the recording medium, for terminating the connection between the proxy and the server without acknowledgment.
